(19) United States
(12) Patent Application Publication
(10) Pub. No.: US 2020/0061470 A1
(43) Pub. Date: Feb. 27, 2020

(54) GAME PROGRAM, AND GAME PROGRAM CONTROL METHOD

(71) Applicant: SQUARE ENIX CO., LTD., Tokyo (JP)

(72) Inventor: Yasuhiro KIDERA, Tokyo (JP)

(73) Assignee: SQUARE ENIX CO., LTD., Tokyo (JP)

(21) Appl. No.: 16/489,109

(22) PCT Filed: Feb. 28, 2017
(86) PCT No.: PCT/JP2017/007869

§ 371 Date: Aug. 27, 2019

(51) Int. Cl. A63F 13/58; A63F 13/537

(52) U.S. Cl. CPC A63F 13/58; A63F 13/537

(57) ABSTRACT

To provide a more interesting game that is a game using the position of a player terminal is an object.

To give an item to a player based on a moving distance of the player. To set a game medium to be givable to the player based on satisfaction of a condition by the item.

### TECHNICAL FIELD

The present invention relates to a game program, and game program control method.

### BACKGROUND ART

In the related art, a game that uses the position of a player terminal measured using a position measuring system such as GPS is known. For example, NPL 1 discloses a game in which a game medium is acquired using an item that a player can obtain by going to a specific position in the real world.

### CITATION LIST

### Non Patent Literature

Non Patent Literature 1: “Pokemon GO” Official Site, [online], [searched on Feb. 3, 2017], Internet (URL: https://support.pokemongo.nianticlabs.com/hc/en-us/articles/221955888-Map-View)

### SUMMARY OF INVENTION

### Technical Problem

The game that uses the position of the player terminal as in NPL 1 has recently drawn attention, and the advent of a more interesting game is expected.

An object of at least one embodiment of the present invention is to solve the problem and provide a more interesting game that is a game using the position of a player terminal.

### Solution to Problem

According to a non-limiting aspect, a game program executed in a computer apparatus connectable by communication to a player terminal operated by a player, the program causing the computer apparatus to function as: an item giver that gives a predetermined item to the player depending on a moving distance of the player terminal in a real world; a transmitter that transmits information related to a game medium givable to the player to the player terminal; and a game medium giver that sets the game medium displayed on the player terminal to be givable to the player based on satisfaction of a predetermined condition by the predetermined item.

According to a non-limiting aspect, a method for controlling a game executed in a game system including a player terminal operated by a player and a computer apparatus connectable by communication to the player terminal, the method comprising: an item giving step of giving a predetermined item to the player depending on a moving distance of the player terminal in a real world; a transmission step of transmitting information related to a game medium givable to the player to the player terminal; a reception step of receiving the information related to the game medium givable to the player from the computer apparatus; a display step of displaying the game medium givable to the player on the player terminal; and a game medium giving step of setting the game medium displayed in the display step to be givable to the player based on satisfaction of a predetermined condition by the predetermined item.

### Advantageous Effects of Invention

One or more of the above problems can be solved with each embodiment of the present invention.

### BRIEF DESCRIPTION OF THE DRAWINGS

FIG. 1 is a block diagram illustrating a configuration of a computer apparatus which corresponds to at least one embodiment of the present invention.

FIG. 2 is a flowchart of the program execution process which corresponds to at least one embodiment of the present invention.

FIG. 3 is a block diagram illustrating a configuration of the game system which corresponds to at least one embodiment of the present invention.

FIG. 4 is a flowchart of the program execution process which corresponds to at least one embodiment of the present invention.

FIG. 5 is a block diagram illustrating a configuration of the player terminal which corresponds to at least one embodiment of the present invention.

FIG. 6 is a flowchart of the program execution process which corresponds to at least one embodiment of the present invention.

FIG. 7 is a block diagram illustrating a configuration of the game system which corresponds to at least one embodiment of the present invention.

FIG. 8 is a block diagram illustrating a configuration of the computer apparatus which corresponds to at least one embodiment of the present invention.

FIG. 9 is a block diagram illustrating a configuration of the player terminal which corresponds to at least one embodiment of the present invention.

FIG. 10 is a block diagram illustrating a configuration of the game system which corresponds to at least one embodiment of the present invention.

FIG. 11 is a flowchart of the program execution process which corresponds to at least one embodiment of the present invention.

FIG. 12 is a flowchart of the program execution process which corresponds to at least one embodiment of the present invention.

FIG. 13 is one example of a master table of the game medium which corresponds to at least one embodiment of the present invention.

FIG. 14 is a diagram illustrating one example of part division of the game medium which corresponds to at least one embodiment of the present invention.

FIG. 15 is one example of the display screen displayed on the player terminal which corresponds to at least one embodiment of the present invention.

### DESCRIPTION OF EMBODIMENTS

Hereinafter, embodiments of the invention will be described with reference to the accompanying drawings. Hereinafter, description relating to effects shows an aspect of the effects of the embodiments of the invention, and does not limit the effects. Further, the order of respective processes that form a flowchart described below may be changed in a range without contradicting or creating discord with the processing contents thereof.

### First Embodiment

First, the outline of a first embodiment of the present invention will be described. In the following description, as the first embodiment, a game program that is executed in a computer apparatus connectable by communication to a player terminal operated by a player will be described with an example.

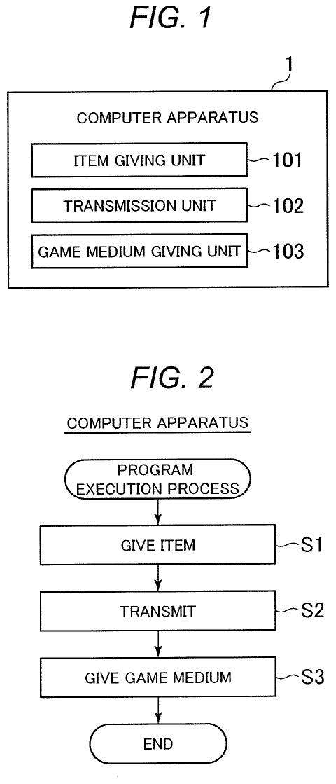

FIG. 1 is a block diagram illustrating a configuration of a computer apparatus which corresponds to at least one embodiment of the present invention. A computer apparatus 1 includes at least an item giving unit 101, a transmission unit 102, and a game medium giving unit 103.

The item giving unit 101 has a function of giving a predetermined item to the player depending on the moving distance of the player terminal in the real world. The transmission unit 102 has a function of transmitting information related to the game medium givable to the player to the player terminal. The game medium giving unit 103 has a function of setting the game medium displayed on the player terminal to be givable to the player based on satisfaction of a predetermined condition by the predetermined item.

Next, a program (game program) execution process in the first embodiment of the present invention will be described. FIG. 2 is a flowchart of the program execution process which corresponds to at least one embodiment of the present invention.

The computer apparatus 1 gives the predetermined item to the player depending on the moving distance of the player terminal in the real world (step S1). Next, the computer apparatus 1 transmits information related to the game medium givable to the player to the player terminal (step S2). Next, the computer apparatus 1 sets the game medium displayed on the player terminal to be givable to the player based on the satisfaction of the predetermined condition by the predetermined item (step S3), and terminates the program execution process.

As one aspect of the first embodiment, a more interesting game that uses the position of the player terminal can be provided.

In the first embodiment, the “player terminal” refers to a terminal such as a mobile phone, a smartphone, a tablet computer, a personal computer, a portable game console, a stationary game console, or the like that can communicate with the computer apparatus and can perform the game execution process. For example, the “player” refers to a user who operates the player terminal and plays the game. For example, the “computer apparatus” refers to an apparatus that executes a process in response to a request from the player terminal. For example, the “game” refers to a computer game executed by running the program in the computer apparatus and/or the player terminal, and the content of the game may be in any genre.

For example, the “moving distance” refers to a moving distance calculated based on positional information related to the player terminal in the real world. Specifically, the moving distance is exemplified by a path distance from a location A to a location B in a case where the player terminal moves from the location A to the location B. For example, the “path distance” may be obtained by calculating the moving trajectory of the player terminal using a GPS sensor or may be calculated by obtaining the positional information related to the player terminal for each predetermined timing and using the difference in position of the player terminal between the predetermined timings. The “positional information” refers to information related to the current position of the player terminal in the real world measured using, for example, the GPS sensor included in the player terminal or a wireless network system of the player terminal. For example, the “position” is not limited to a two-dimensional position indicated by a latitude and a longitude and may be a concept including a height.

The “predetermined item” is not particularly limited, provided that the predetermined item is used for acquiring the game medium. For example, the predetermined item is exemplified by an item that the player uses in order to acquire the game medium in an event for acquiring the game medium. The case of “giving the predetermined item to the player depending on the moving distance” also includes a case where a predetermined point is given to the player, and the predetermined item is set to be usable based on the point or the point is exchanged for the predetermined item.

For example, “giving” refers to associating the game medium with the player and enabling the player to use the game medium in the game. For example, “associating the game medium with the player” refers to an update of player information such that information related to the game medium is included in the player information managed by the computer apparatus. In addition, “giving” includes a case such as rental where the player can use the game medium for a certain period.

For example, the “game medium” refers to digital contents used by the player in the game and is exemplified by a card, a character, a weapon, armor, an item, or an avatar. For example, the “information related to the game medium” refers to status information such as offensive power and defensive power set for the game medium or information necessary for displaying the game medium on the player terminal.

For example, the “predetermined condition” is a condition set for setting the game medium to be givable to the player. Specifically, the predetermined condition is exemplified by having the number of possessions of the predetermined items greater than or equal to a certain number or exerting a predetermined action or effect on the game medium in the event for acquiring the game medium. The “predetermined condition” is not limited to the above example and can be appropriately set depending on the content of the game.

### Second Embodiment

Next, the outline of a second embodiment of the present invention will be described. In the following description, as the second embodiment, a game program that is executed in a computer apparatus connectable by communication to a player terminal operated by a player will be described with an example.

Regarding a configuration of the computer apparatus in the second embodiment, the configurations illustrated in the block diagram in FIG. 1 can be adopted within a necessary range. In addition, regarding a flow of program execution process in the second embodiment, the flow illustrated in the flowchart in FIG. 2 can be adopted within a necessary range.

In the second embodiment, the game medium giving unit 103 has a function of setting the game medium displayed on the player terminal to be givable to the player based on a contact of the predetermined item with the game medium displayed on the player terminal by an operation performed on the player terminal.

In the second embodiment, in step S3, the game medium displayed on the player terminal is set to be givable to the player based on a contact of the predetermined item with the game medium displayed on the player terminal by an operation performed on the player terminal.

As one aspect of the second embodiment, by setting the game medium displayed on the player terminal to be givable to the player based on a contact of the predetermined item with the game medium displayed on the player terminal by an operation performed on the player terminal, the interest of the game can be improved.

In the second embodiment, regarding each of the “player terminal”, the “player”, the “computer apparatus”, the “game”, the “moving distance”, the “path distance”, the “positional information”, the “position”, the predetermined item”, “giving”, the “game medium”, and the “information related to the game medium”, the contents disclosed in the first embodiment can be adopted within a necessary range. In addition, in the second embodiment, for example, “contact” refers to a determination that the predetermined item collides or comes into contact with the game medium in the game.

### Third Embodiment

Next, the outline of a third embodiment of the present invention will be described. In the following description, as the third embodiment, a game program that is executed in a computer apparatus connectable by communication to a player terminal operated by a player will be described with an example.

Regarding a configuration of the computer apparatus in the third embodiment, the configurations illustrated in the block diagram in FIG. 1 can be adopted within a necessary range. In addition, regarding a flow of program execution process in the third embodiment, the flow illustrated in the flowchart in FIG. 2 can be adopted within a necessary range.

In the third embodiment, the game medium giving unit 103 has a function of setting the game medium displayed on the player terminal to be givable to the player based on the number or amount of the predetermined item satisfying the predetermined condition.

In the third embodiment, in step S3, the game medium displayed on the player terminal is set to be givable to the player based on the number or amount of the predetermined item satisfying the predetermined condition.

As one aspect of the third embodiment, by setting the game medium displayed on the player terminal to be givable to the player based on the number or amount of the predetermined item satisfying the predetermined condition, the interest of the game can be improved.

In the third embodiment, regarding each of the “player terminal”, the “player”, the “computer apparatus”, the “game”, the “moving distance”, the “path distance”, the “positional information”, the “position”, the predetermined item”, “giving”, the “game medium”, the “information related to the game medium”, and the “predetermined condition”, the contents disclosed in the first embodiment can be adopted within a necessary range.

### Fourth Embodiment

Next, the outline of a fourth embodiment of the present invention will be described. In the following description, as the fourth embodiment, a game program that is executed in a computer apparatus connectable by communication to a player terminal operated by a player will be described with an example.

Regarding a configuration of the computer apparatus in the fourth embodiment, the configurations illustrated in the block diagram in FIG. 1 can be adopted within a necessary range. In addition, regarding a flow of program execution process in the fourth embodiment, the flow illustrated in the flowchart in FIG. 2 can be adopted within a necessary range.

In the fourth embodiment, the game medium giving unit 103 has a function of giving the game medium displayed on the player terminal to the player with a higher probability as the number or amount of the predetermined item satisfying the predetermined condition is increased.

In the fourth embodiment, in step S3, the game medium displayed on the player terminal is given to the player with a higher probability as the number or amount of the predetermined item satisfying the predetermined condition is increased.

As one aspect of the fourth embodiment, by giving the game medium displayed on the player terminal to the player with a higher probability as the number or amount of the predetermined item satisfying the predetermined condition is increased, the interest of the game can be improved.

In the fourth embodiment, regarding each of the “player terminal”, the “player”, the “computer apparatus”, the “game”, the “moving distance”, the “path distance”, the “positional information”, the “position”, the predetermined item”, “giving”, the “game medium”, the “information related to the game medium”, and the “predetermined condition”, the contents disclosed in the first embodiment can be adopted within a necessary range.

### Fifth Embodiment

Next, the outline of a fifth embodiment of the present invention will be described. In the following description, as the fifth embodiment, a game system implemented by a player terminal operated by a player and a computer apparatus connectable by communication to the player terminal will be described with an example.

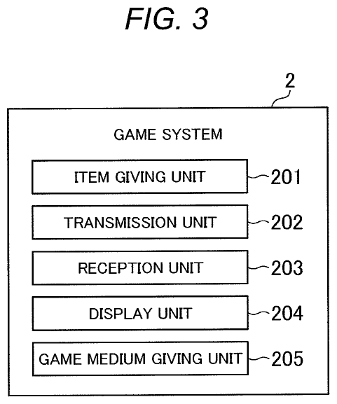

FIG. 3 is a block diagram illustrating a configuration of the game system which corresponds to at least one embodiment of the present invention. A game system 2 includes at least an item giving unit 201, a transmission unit 202, a reception unit 203, a display unit 204, and a game medium giving unit 205.

The item giving unit 201 has a function of giving a predetermined item to the player depending on the moving distance of the player terminal in the real world. The transmission unit 202 has a function of transmitting information related to a game medium givable to the player to the player terminal. The reception unit 203 has a function of receiving the information related to the game medium givable to the player from the computer apparatus. The display unit 204 has a function of displaying the game medium givable to the player on the player terminal. The game medium giving unit 205 has a function of setting the game medium displayed on the display unit 204 to be givable to the player based on satisfaction of a predetermined condition by the predetermined item.

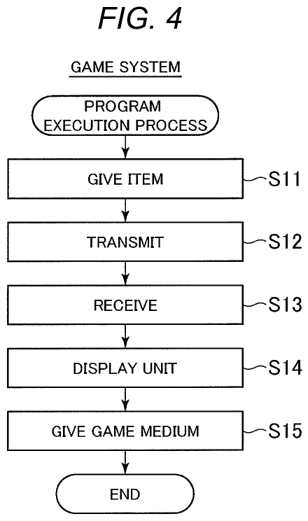

Next, a program (game program) execution process in the fifth embodiment of the present invention will be described. FIG. 4 is a flowchart of the program execution process which corresponds to at least one embodiment of the present invention.

The game system 2 gives the predetermined item to the player depending on the moving distance of the player terminal in the real world (step S11). Next, the game system 2 transmits the information related to the game medium givable to the player to the player terminal (step S12). Next, the game system 2 receives the information related to the game medium givable to the player from the computer apparatus (step S13). Next, the game system 2 displays the game medium givable to the player on the player terminal (step S14). Next, the game system 2 sets the game medium displayed in step S14 to be givable to the player based on the satisfaction of the predetermined condition by the predetermined item (step S15), and terminates the program execution process.

As one aspect of the fifth embodiment, a more interesting game that uses the position of the player terminal can be provided.

In the fifth embodiment, regarding each of the “player terminal”, the “player”, the “computer apparatus”, the “game”, the “moving distance”, the “path distance”, the “positional information”, the “position”, the predetermined item”, “giving”, the “game medium”, the “information related to the game medium”, and the “predetermined condition”, the contents disclosed in the first embodiment can be adopted within a necessary range.

### Sixth Embodiment

Next, the outline of a sixth embodiment of the present invention will be described. In the following description, as the sixth embodiment, a game program executed in a player terminal in a game system implemented by the player terminal operated by a player and a computer apparatus connectable by communication to the player terminal will be described with an example.

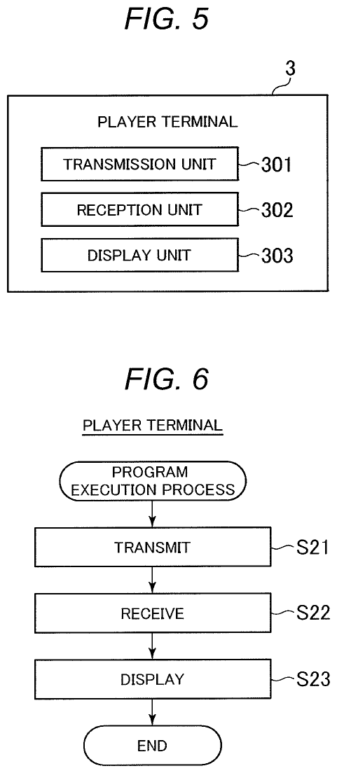

FIG. 5 is a block diagram illustrating a configuration of the player terminal which corresponds to at least one embodiment of the present invention. A player terminal 3 includes at least a transmission unit 301, a reception unit 302, and a display unit 303.

The transmission unit 301 has a function of transmitting positional information related to the position of the player terminal in the real world to the computer apparatus. The reception unit 302 has a function of receiving information related to a game medium givable to the player from the computer apparatus. The display unit 303 has a function of displaying the game medium based on the information which is related to the game medium and is received by the reception unit 302.

The game system gives a predetermined item to the player depending on the moving distance of the player terminal in the real world. In addition, the game system transmits the information related to the game medium givable to the player to the player terminal. In addition, the game system gives the game medium displayed on the player terminal to the player based on satisfaction of a predetermined condition by the predetermined item.

Next, a program (game program) execution process in the sixth embodiment of the present invention will be described. FIG. 6 is a flowchart of the program execution process which corresponds to at least one embodiment of the present invention.

The player terminal transmits the positional information related to the position of the player terminal in the real world to the computer apparatus (step S21). Next, the player terminal receives the information related to the game medium givable to the player from the computer apparatus (step S22). Next, the player terminal displays the game medium based on the information which is related to the game medium and is received in step S22 (step S23), and terminates the program execution process.

As one aspect of the sixth embodiment, a more interesting game that uses the position of the player terminal can be provided.

In the sixth embodiment, regarding each of the “player terminal”, the “player”, the “computer apparatus”, the “game”, the “moving distance”, the “path distance”, the “positional information”, the “position”, the predetermined item”, “giving”, the “game medium”, the “information related to the game medium”, and the “predetermined condition”, the contents disclosed in the first embodiment can be adopted within a necessary range.

### Seventh Embodiment

Next, the outline of a seventh embodiment of the present invention will be described. In the following description, as the seventh embodiment, a game system implemented by a player terminal operated by a player and a computer apparatus connectable by communication to the player terminal will be described with an example.

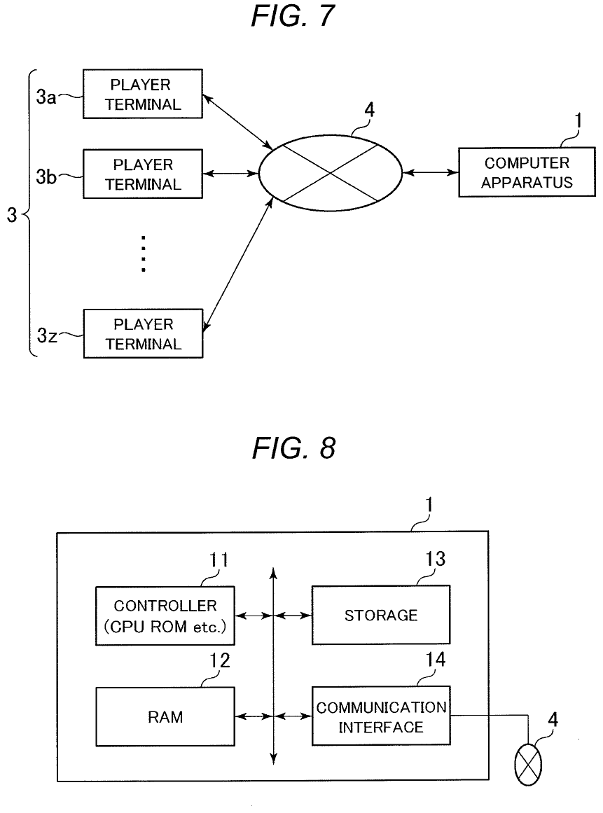

FIG. 7 is a block diagram illustrating a configuration of the game system which corresponds to at least one embodiment of the present invention. As illustrated, the game system is configured with the computer apparatus 1, a communication network 4, and a plurality of player terminals 3 (3a, 3b, . . . , 3z) operated by individual players. The computer apparatus 1 is connected to the player terminals 3 through the communication network 4. The computer apparatus 1 may not be constantly connected to the player terminals 3 or may be able to be connected as necessary.

FIG. 8 is a block diagram illustrating a configuration of the computer apparatus which corresponds to at least one embodiment of the present invention. The computer apparatus 1 includes at least a controller 11, a random access memory (RAM) 12, a storage 13, and a communication interface 14 that are connected to each other through an internal bus.

The controller 11 is configured with a central processing unit (CPU) and a read only memory (ROM), executes a program stored in the storage 13, and controls the computer apparatus 1. In addition, the controller 11 includes an internal timer that tracks time. The RAM 12 is a work area of the controller 11. The storage 13 is a storage region for storing the program (including a game program) and data (including game data). The controller 11 reads the program and the data from the RAM 12 and performs a program execution process based on information and the like received from the player terminals 3.

The communication interface 14 can be connected to the communication network 4 in a wireless or wired manner and can transmit and receive data through the communication network 4. For example, data received through the communication interface 42 is loaded into the RAM 12 and is subjected to a calculation process by the controller 11.

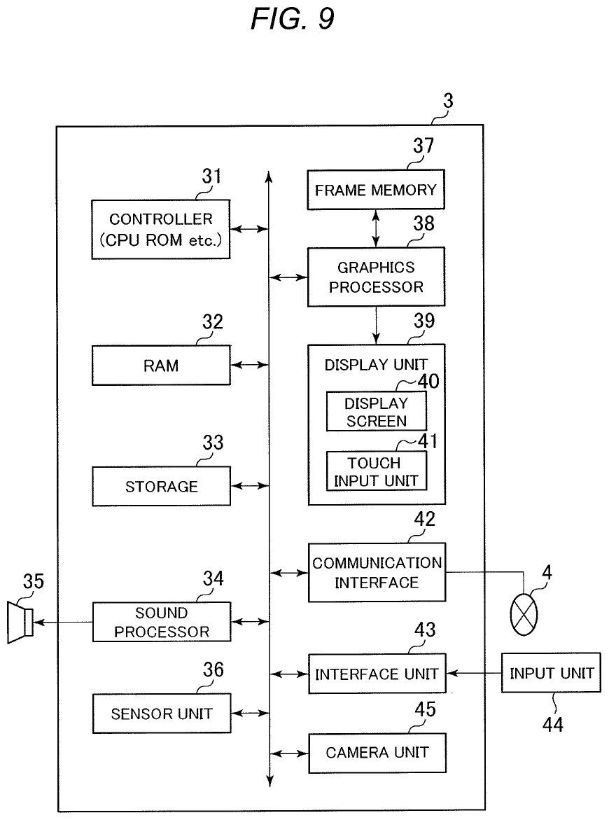

FIG. 9 is a block diagram illustrating a configuration of the player terminal which corresponds to at least one embodiment of the present invention. The player terminal 3 includes at least a controller 31, a RAM 32, a storage 33, a sound processor 34, a sensor unit 36, a graphics processor 38, a display unit 39, a communication interface 42, and an interface unit 43 that are connected to each other through an internal bus.

The controller 31 is configured with a CPU and a ROM. In addition, the controller 31 includes an internal timer that tracks time. The controller 31 executes a program stored in the storage 33 and controls the player terminal 3. The RAM 32 is a work area of the controller 31. The storage 33 is a storage region for storing the program and data.

The controller 31 reads a program and data from the RAM 32 and processes the program and the data. By processing the program and the data loaded in the RAM 32, the controller 31 outputs a sound output instruction to the sound processor 34 and outputs an image rendering instruction to the graphics processor 38.

The sound processor 34 is connected to a sound output device 35 that is a speaker. In a case where the controller 31 outputs the sound output instruction to the sound processor 34, the sound processor 34 outputs a sound signal to the sound output device 35.

The sensor unit 36 includes a GPS sensor. In addition, the sensor unit 36 may include various other sensors. For example, various sensors are exemplified by a fingerprint authentication sensor, a proximity sensor, an acceleration sensor, a gyrosensor, a magnetic field sensor, a brightness sensor, or a barometric pressure sensor.

The graphics processor 38 is connected to the display unit 39. The display unit 39 includes a display screen 40. In a case where the controller 31 outputs the image rendering instruction to the graphics processor 38, the graphics processor 38 loads an image into a frame memory (frame buffer) 37 and outputs a video signal for displaying the image on the display screen 40. The display unit 39 may be a screen of a touch panel including a touch input unit 41.

The graphics processor 38 renders one image in frame units. For example, a time of one frame of the image is 1/30 seconds. The graphics processor 38 distributes the workload of the whole system by performing a part of a calculation process related to image rendering performed by only the controller 31.

The communication interface 42 can be connected to the communication network 4 in a wireless or wired manner and can transmit and receive data through the communication network 4. Data received through the communication interface 42 is loaded into the RAM 32 and is subjected to a calculation process by the controller 31 in the same manner as data read from an external memory.

An input unit 44 (for example, a mouse or a keyboard) may be connected to the interface unit 43. Input information provided by the player from the input unit 44 is stored in the RAM 32, and the controller executes various calculation processes based on the input information. Alternatively, a storage medium reading device can be connected to the interface unit 43, and a program, data, and the like can be read from the external memory. In addition, the display unit 39 including a touch panel can be used as the input unit 44.

The camera unit 45 captures the surrounding area of the player terminal 3. The image captured by the camera unit 45 is output to the graphics processor 38.

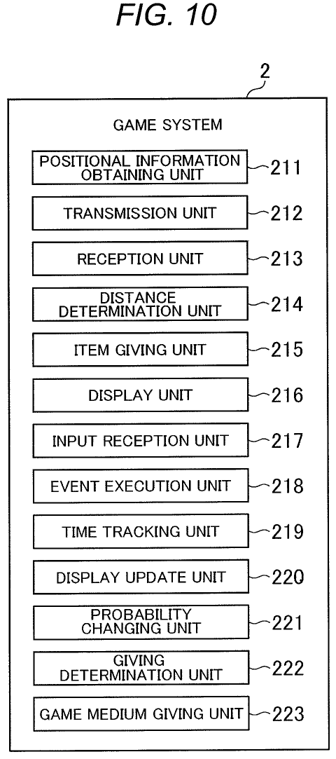

FIG. 10 is a block diagram illustrating a configuration of the game system which corresponds to at least one embodiment of the present invention. The game system 2 includes at least a positional information obtaining unit 211, a transmission unit 212, a reception unit 213, a distance determination unit 214, an item giving unit 215, a display unit 216, an input reception unit 217, an event execution unit 218, a time tracking unit 219, a display update unit 220, a probability changing unit 221, a giving determination unit 222, and a game medium giving unit 223.

The positional information obtaining unit 211 has a function of obtaining positional information related to the position of the player terminal in the real world. The positional information is preferably obtained by measuring the position using, for example, the GPS sensor included in the player terminal or a wireless network system of the player terminal. For example, the positional information is obtained as coordinates of a specific point.

The transmission unit 212 includes a transmission unit 212a included in the player terminal 3 and a transmission unit 212b included in the computer apparatus 1. The transmission unit 212a has a function of transmitting information related to a game to the computer apparatus 1 from the player terminal 3. For example, the positional information which is related to the player terminal and is obtained by the positional information obtaining unit 211, and information related to the result of an event are transmitted to the computer apparatus 1 by the transmission unit 212a. The positional information related to the player terminal is transmitted to the computer apparatus from the player terminal 3 automatically or based on an operation performed by the player for each predetermined timing. For example, the information which is related to the result of the event and is transmitted by the transmission unit 212a is exemplified by the giving probability of a game medium that changes depending on the progress of the event.

The transmission unit 212b has a function of transmitting the information related to the game to the player terminal 3 from the computer apparatus 1. For example, information related to the game medium givable to the player and information related to an item and the game medium given to the player are transmitted to the player terminal 3 by the transmission unit 212b. For example, the information which is related to the game medium and is transmitted by the transmission unit 212b is preferably extracted from information stored in the storage 13 of the computer apparatus 1 based on the positional information related to the player terminal 3. Such a configuration can increase the ability of interaction between the game and the real world and can improve the interest of the game.

The information which is related to the game medium and is transmitted by the transmission unit 212b preferably includes information related to a plurality of game media. In addition, the information which is related to the game medium and is transmitted by the transmission unit 212b preferably includes information related to the giving probability of the game medium. For example, the giving probability of the game medium is preferably set depending on an attribute (rarity or the like) set for the game medium. Specifically, it is preferable to set the giving probability to be decreased as the rarity of the game medium is increased.

The reception unit 213 includes a reception unit 213a included in the player terminal 3 and a reception unit 213b included in the computer apparatus 1. The reception unit 213a has a function of receiving the information which is related to the game and is transmitted to the player terminal 3 from the computer apparatus 1 by the transmission unit 212b. The reception unit 213b has a function of receiving the information which is related to the game and is transmitted to the computer apparatus 1 from the player terminal 3 by the transmission unit 212a.

The distance determination unit 214 has a function of determining whether or not the moving distance of the player terminal 3 in the real world exceeds a predetermined distance (for example, 100 m) using the positional information related to the player terminal 3 in the real world. For example, each time the cumulative moving distance of the player terminal 3 exceeds the predetermined distance, the distance determination unit 214 determines that the predetermined distance is exceeded. Specifically, in a case where the predetermined distance is 100 m, each time the cumulative moving distance of the player terminal 3 exceeds 100 m, 200 m, and 300 m, it is determined that the predetermined distance is exceeded. The cumulative moving distance may be reset (set to zero) in a case where the predetermined distance is exceeded, or may be configured to be reset at a time when a predetermined period elapses.

The predetermined distance can be appropriately set depending on the content of the game. In addition, the predetermined distance may be changed based on player information such as the level of the player or the use of an item or a skill by the player, and may be changed during a specific period such as the period of the event.

In addition, the distance determination unit 214 may have a function of determining the moving speed of the player terminal 3. For example, in a case where the distance determination unit 214 determines that the player terminal 3 is moving at a speed (for example, 20 km per hour) that is significantly higher than a general walking speed of a person, the distance determination unit 214 may be configured not to add the moving distance of the player terminal 3 during the movement as the moving distance.

The item giving unit 215 has a function of giving a predetermined item to the player in a case where the distance determination unit 214 determines that the cumulative moving distance of the player terminal 3 exceeds the predetermined distance. The number, amount, or type of the predetermined item given to the player can be appropriately set depending on the content of the game. In addition, for example, the item giving unit 215 preferably gives a predetermined benefit to the player based on the number of times that the predetermined item is given or based on the cumulative moving distance of the player terminal exceeding a predetermined threshold. For example, the predetermined benefit is exemplified by increasing the number or amount of the given item or giving an item of a higher value in the game than the predetermined item typically given. Such a configuration can more strongly motivate the player to move a long distance and can improve the interest of the game.

The display unit 216 has a function of displaying the game medium on the display screen of the player terminal based on the information which is related to the game medium and is received by the reception unit 213a. In the present embodiment, the game medium is displayed on the display screen in a screen for selecting the game medium that the player desires to be given, a screen during execution of an event for receiving the game medium, and the like. For example, the display unit 216 preferably displays the game medium on an image of a map corresponding to the real world in the screen for selecting the game medium that the player desires to be given. In addition, for example, the display unit 216 preferably displays the game medium on an image based on the image of the surrounding area of the player terminal captured by the camera unit 45 in the screen during the execution of the event for receiving the game medium. Such a configuration can increase the ability of interaction between the game and the real world and can improve the interest of the game.

The input reception unit 217 has a function of receiving an operation input provided to the player terminal by the player. For example, the operation input of the player can be provided by operating a button, a stick, or the like included in the player terminal or performing a touch operation, a swipe operation, or the like on the touch panel.

The event execution unit 218 has a function of executing the event for giving the game medium displayed on the display unit 216 to the player. For example, the event progresses depending on the operation input of the player received by the input reception unit 217. The content of the event is not particularly limited, provided that the predetermined item given by the item giving unit 215 is used. The content of the event can be appropriately set depending on the content of the game. Specifically, the content of the event is exemplified by a virtual battle with the game medium using the predetermined item, hitting the game medium with the predetermined item, or the like.

The time tracking unit 219 has a function of tracking time from the start of the event by the event execution unit 218. For example, the time tracking unit 219 tracks time using the internal timer included in the controller 31. For example, by including the time tracking unit 219, a predetermined time limit can be set for the execution time of the event. The predetermined time limit is not particularly limited and may be appropriately set to, for example, 30 seconds or 1 minute depending on the content of the game and the attribute (for example, the rarity) of the game medium.

The display update unit 220 has a function of updating (changing) the display state of the game medium depending on the progress of the event by the event execution unit 218. For example, the display update unit 220 preferably changes the color or shape of the game medium or changes the display position of the game medium depending on the progress of the event. Such a configuration can improve the interest of the game.

The probability changing unit 221 has a function of changing the giving probability set for the game medium depending on the progress or result of the event. For example, in a case where the content of the event is the virtual battle with the game medium, the giving probability can be increased based on the amount of damage dealt to the game medium, and the giving probability can be decreased based on the amount of damage received by the game medium possessed by the player. In addition, for example, in the case of the game in which the content of the event is hitting the game medium with the predetermined item, the giving probability can be increased based on the number or amount of the predetermined item hitting the game medium.

In addition, the probability changing unit 221 may change the range of change of the giving probability depending on the state of the game medium that is a giving target in the event. For example, in a case where the predetermined item hits the game medium when the game medium is in a defensive state, the value of increase in giving probability can be set to be smaller than that when the game medium is in a typical state. In addition, for example, in a case where the predetermined item hits the game medium when the game medium is in a down state, the value of increase in giving probability can be set to be greater than that when the game medium is in the typical state. Such a configuration adds a game quality of considering the timing of using the predetermined item, and can improve the interest of the game.

In addition, the probability changing unit 221 may change the range of change of the giving probability depending on a part of the game medium on which the predetermined item exerts a predetermined action. For example, the range of change of the giving probability can be changed when the predetermined item hits a head part of the game medium, and when the predetermined item hits a torso part of the game medium. Such a configuration adds a game quality of considering a position at which the predetermined item exerts the action and providing an appropriate operation input in order to exert the action at the aimed position, and can improve the interest of the game.

The giving determination unit 222 has a function of determining whether or not to give the game medium to the player based on the information which is related to the result of the event and is received by the reception unit 213b. For example, the giving determination unit 222 determines whether or not to give the game medium to the player based on the giving probability of the game medium changed by the probability changing unit 221. The game medium giving unit 223 has a function of giving the game medium to the player in a case where the giving determination unit 222 determines to give the game medium to the player.

Next, a program execution process in the seventh embodiment of the present invention will be described. In the following description, as one example of the game, a role playing game in which the game progresses using the positional information related to the player terminal and the game medium possessed by the player (usable by the player) will be described. The genre of the game is not limited to the role playing game. For example, the program execution process can be applied to a simulation game or an action game regardless of genre.

In addition, in the following description, a “heart” and a “diamond” will be described as the predetermined item given to the player depending on the moving distance of the player terminal. The “heart” is an item that is given each time the cumulative moving distance of the player terminal exceeds the unit of 100 m. The “diamond” is an item exhibiting a more advantageous effect than the “heart” with respect to giving of the game medium and is an item that is given each time the cumulative moving distance of the player terminal exceeds the unit of 1 km. In addition, the “diamond” is given to the player in a case where the player pays a charge. The predetermined item and the condition for giving the predetermined item are not limited to the above example and can be appropriately set depending on the content of the game.

In addition, in the following description, a game in which the game medium displayed on the display screen is hit with the “heart” and the “diamond” will be described as the event for giving the game medium to the player. The player increases the giving probability of the game medium by hitting the game medium with the “heart” or the “diamond”, and a determination as to whether or not to give the game medium to the player is performed based on the giving probability after increase. The content of the event is not limited to the above example and can be appropriately set depending on the content of the game.

A status (for example, offensive power, defensive power, and the maximum hit point) used in the game, an attribute (for example, rarity and species), a skill having a predetermined effect, and the like are set for the game medium. The player selects any game medium from possessed game media and, for example, performs the event for receiving the game medium or virtually battles with an enemy character or another player. In addition, the rarity is set for the game medium. As the rarity of the game medium is increased, the degree of rareness in the game is increased. In addition, it is preferable to set the giving probability for the player to be decreased as the rarity of the game medium is increased. In addition, it is preferable to set a higher status used in the game for the game medium of high rarity than for the game medium of low rarity.

In the computer apparatus, the information related to the plurality of game media givable to the player is stored in association with a position or a region in the real world. In addition, information related to the map corresponding to the real world is stored in the computer apparatus. For example, information related to the game medium and the item possessed by the player is managed by the computer apparatus or the player terminal as the player information. In the case of giving the game medium to the player, the player information is updated such that information related to the given game medium is included in the player information.

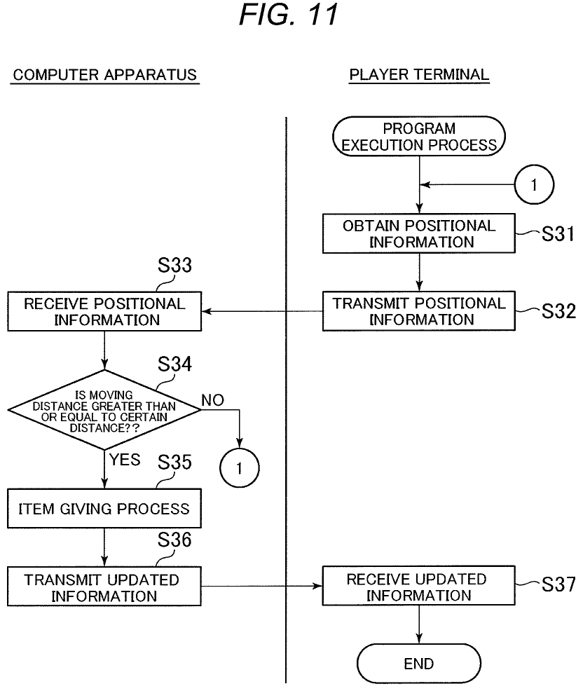

FIG. 11 is a flowchart of the program execution process which corresponds to at least one embodiment of the present invention. Specifically, FIG. 11 is a flowchart of the program execution process in the case of giving the predetermined item to the player depending on the moving distance of the player terminal.

First, in the player terminal, the positional information related to the position of the player terminal in the real world is obtained (step S31). The positional information is obtained by measuring the position using, for example, the GPS sensor included in the player terminal or the wireless network system of the player terminal. Next, the player terminal transmits the positional information obtained in step S31 to the computer apparatus (step S32). While the game is running in the player terminal, it is preferable for step S31 and step S32 to be repeated at a predetermined interval either in the foreground or in the background.

Next, the computer apparatus receives the positional information related to the player terminal from the player terminal (step S33). Next, the computer apparatus determines whether or not the cumulative moving distance of the player terminal calculated based on the received positional information exceeds the unit of 100 m (step S34). In a case where it is determined that the cumulative moving distance of the player terminal does not exceed the unit of 100 m (No in step S34), a return is made to step S31. In a case where it is determined that the cumulative moving distance of the player terminal exceeds the unit of 100 m (Yes in step S34), the computer apparatus performs a process of giving a predetermined number of “hearts” to the player (step S35). Specifically, a process of updating the player information to include information related to the predetermined number of “hearts” is performed.

The process of giving the “heart” in step S35 is executed each time when it is determined that the cumulative moving distance of the player terminal exceeds the unit of 100 m. In addition, in step S34, a determination as to whether or not the cumulative moving distance of the player terminal exceeds the unit of 1 km is also performed. In step S34, in a case where it is determined that the cumulative moving distance of the player terminal exceeds the unit of 1 km, a process of giving a predetermined number of “diamonds” to the player along with the predetermined number of “hearts” is performed in step S35.

Next, the computer apparatus transmits the updated information to the player terminal (step S36). Next, the player terminal receives the information from the computer apparatus (step S37) and terminates the program execution process.

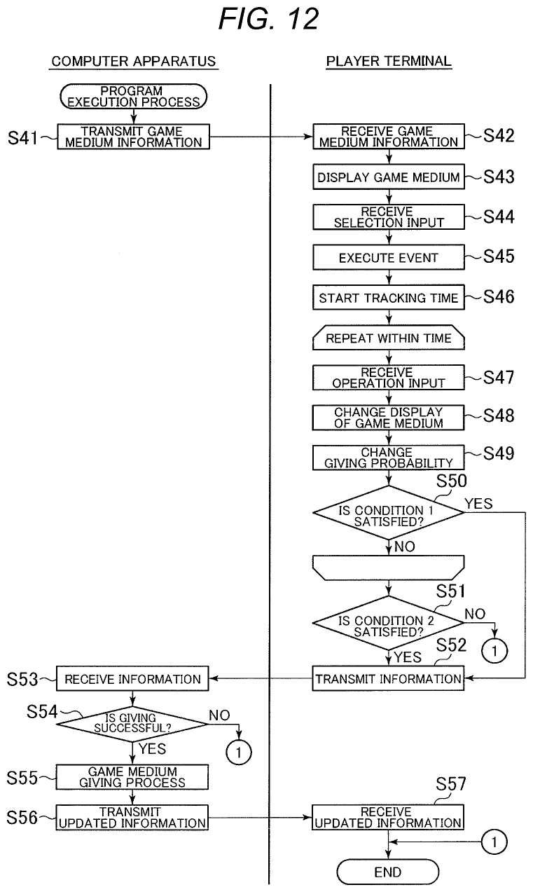

FIG. 12 is a flowchart of the program execution process which corresponds to at least one embodiment of the present invention. Specifically, FIG. 12 is a flowchart of the program execution process in the case of giving the game medium to the player based on the predetermined item.

First, the computer apparatus transmits the information related to the game medium displayed on the player terminal to the player terminal (step S41). The information related to the game medium includes the information related to the giving probability of the game medium and the like. In addition, for example, the information which is related to the game medium and is transmitted in step S41 is preferably extracted from the information stored in the storage 13 of the computer apparatus based on the positional information related to the player terminal 3. In addition, the information related to the game medium preferably includes the information related to the plurality of game media.

Next, the player terminal receives the information transmitted from the computer apparatus in step S41 (step S42). Next, the player terminal displays the game medium on the display screen of the player terminal based on the information received in step S42 (step S43). In a case where the information related to the plurality of game media is received in step S42, the game media not exceeding a predetermined number are displayed on the player terminal. In addition, for example, the displayed game media may be decided by drawing the game media from the plurality of game media randomly or based on an appearance probability set for each game medium in the player terminal.

In addition, in step S42, the game medium is preferably displayed on the image of the map corresponding to the position of the player terminal in the real world. Such a configuration can cause the player to feel that the game medium appears in the real world, and can improve the interest of the game. Information for displaying the image of the map corresponding to the position of the player terminal in the real world may be received from the computer apparatus or may be obtained from the storage 33 of the player terminal.

Next, the player terminal receives an operation input for selecting the displayed game medium and executing the event related to the game medium (step S43). Next, the player terminal executes the event for giving the game medium to the player (step S45). Immediately after the start of the execution of the event, for example, the name of the game medium and the rarity of the game medium are preferably displayed in accordance with the image of the game medium.

In addition, immediately after the start of the execution of the event, it is preferable to provide a configuration in which the player selects the game medium used in the event from the game media possessed by the player, and a predetermined effect is exerted on the event based on the game medium. Such a configuration can improve the strategic quality of the game. The game medium used in the event may be selected before the start of the execution of the event.

The predetermined effect is not particularly limited. For example, it is preferable to change the giving probability of the game medium as the giving target based on the game medium used in the event. Specifically, it is preferable to change the giving probability of the game medium based on a relationship between the attribute set for the game medium used in the event and the attribute set for the game medium as the giving target. In such a configuration, as the number of types of possessed game media is increased, the range of selection is increased, and the event can proceed advantageously. Thus, the player can be motivated to collect many types of game media.

In addition, for example, the predetermined effect is exemplified by an effect advantageous to the player such as substantially extending the time limit of the event or stopping the motion of the game medium as the giving target based on the skill and the like set for the game medium. Such a configuration can motivate the player to collect the game medium having a better skill and the like.

In addition, in step S45, immediately after the start of the execution of the event, the image of the game medium is displayed in a state of coloring set as a typical image of the game medium. Then, at a predetermined timing, the image of the game medium is displayed in a state where at least one of hue, brightness, or saturation is changed. The predetermined timing is not particularly limited and is preferably, for example, a time before reception of an operation performed by the player is enabled. For example, the change of the image of the game medium is exemplified by displaying the image of the game medium by changing the image of the game medium to be monochrome, monotone, or transparent. In step S48 described below, the image of the game medium of which the hue is changed may be restored to the state of coloring set for the game medium.

In addition, during the execution of the event, the image of the game medium is preferably displayed on the image based on the image of the surrounding area of the player terminal captured by the camera unit 45. Such a configuration can cause the player to feel that the game medium appears in the real world, and can improve the interest of the game.

In addition, for example, the image captured by the camera unit 45 is preferably displayed in a different manner depending on the rarity of the game medium. Specifically, it is preferable to change at least one of the hue, brightness, or saturation of the image depending on the rarity of the game medium. Such a configuration can provide a special effect in a case where the rarity of the game medium is high, and can improve the interest of the game.

At a time when a predetermined time elapses from the start of the event, the player terminal is set to be in a state where an operation performed by the player can be received. In the state where an operation performed by the player can be received, the player terminal starts tracking time (step S46). The time tracking continues until the predetermined time limit set for the event elapses, or it is determined that a predetermined condition 1 is satisfied in step S50 described below.

Next, the player terminal receives an operation input for hitting the game medium with the “heart” or the like (step S47). For example, the “heart” or the like is ejected by receiving a flick operation, a tap operation, or a touch operation performed by the player. Next, the player terminal restores the hue and the like of the image of the game medium to the state set for the game medium depending on the number of “hearts” or the like hitting the game medium and displays the image of the game medium (step S48). In addition, the player terminal changes the giving probability of the game medium depending on the number of “hearts” or the like hitting the game medium (step S49).

By changing the display state of the game medium depending on the number of “hearts” or the like hitting the game medium and changing the giving probability of the game medium depending on the number of “hearts” or the like hitting the game medium, the display state of the game medium has an indirect correlation with the giving probability of the game medium. Accordingly, for example, by displaying the game medium by restoring the monochromatically displayed game medium to the state set for the game medium in a stepwise manner depending on the number of “hearts” or “diamonds” hitting the game medium, the player can perceive the value of increase in giving probability of the game medium from the display state of the game medium. Consequently, the player does not need to perform a motion such as taking eyes off the game medium in order to check the current giving probability, and can focus on the operation for hitting the game medium with the “heart” or the like. The display state of the game medium may be configured to be changed depending on the value of increase in giving probability of the game medium.

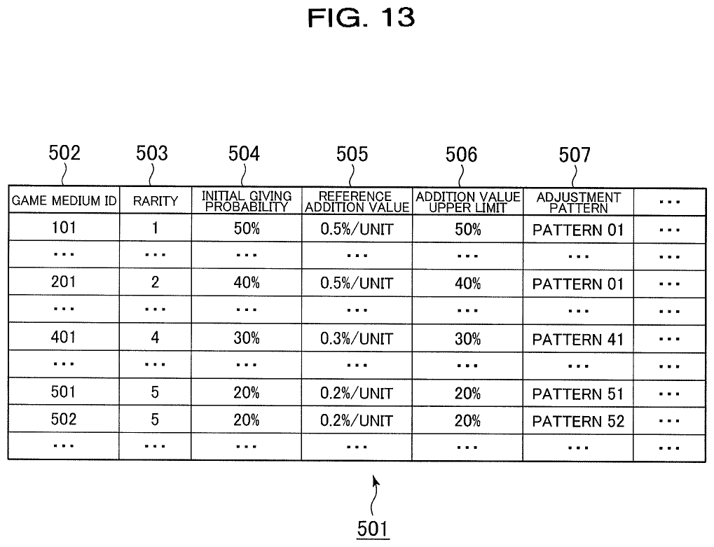

FIG. 13 is one example of a master table of the game medium which corresponds to at least one embodiment of the present invention. A master table 501 stores rarity 503, an initial giving probability 504, a reference addition value 505, an addition value upper limit 506, and an adjustment pattern 507 in association with a game medium ID 502 for identifying the game medium. The master table 501 is merely one example and may include other information. For example, other information is exemplified by the time limit of the event. The master table 501 may be stored in the storage 13 of the computer apparatus or may be stored in any of the storage 33 of the player terminal or the external memory.

The rarity 503 shows the rarity set for the game medium. In the present embodiment, to assume that the highest rarity is “5”, the rarity is decreased as the number decreases, and the lowest rarity is “1”. The initial giving probability 504 shows the giving probability of the game medium at the start (initial period) of the event. The reference addition value 505 shows an addition value as a reference that is added to the initial giving probability when one “heart” hits the game medium. The reference addition value 505 is adjusted in accordance with a pattern shown in the adjustment pattern 507 described below. The addition value after adjustment is added to the giving probability. For example, the reference addition value when one “diamond” hits the game medium can be set to a value obtained by multiplying the value shown in the reference addition value 505 by a predetermined factor (for example, a factor of 2). The addition value upper limit 506 shows the upper limit of the addition value addable to the initial giving probability.

For example, the game medium having the game medium ID 502 of “201” has a giving probability of “40%” at the start of the event. In a case where adjustment based on the adjustment pattern 507 is not performed, the giving probability of the game medium “201” is changed by “+0.5%” each time one “heart” hits the game medium “201”. In a case where the total of the addition value reaches “50%” that is the upper limit, further addition is not performed. In a case where the total of the addition value reaches the upper limit, for example, the game of hitting with the “heart” is stopped or terminated, and a transition is made to step S52 described below with the final giving probability of the game medium as “90%”.

The adjustment pattern 507 is for adjusting the addition value as a reference shown in the reference addition value 505. The adjustment pattern is not particularly limited and is preferably a pattern based on the part of the game medium hit by the “heart” or the like. As described above, by adjusting the addition value depending on the part hit by the “heart” or the like, a game quality of determining which part is hit by the “heart” or the like is added, and the interest of the game can be improved.

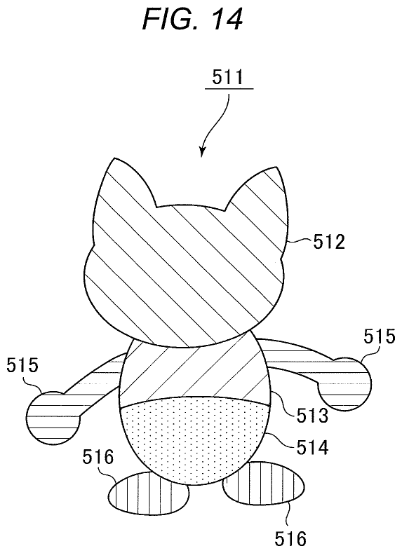

FIG. 14 is a diagram illustrating one example of part division of the game medium which corresponds to at least one embodiment of the present invention. A game medium 511 is divided into five parts including a head part 512, a torso part 513, a waist part 514, an arm part 515, and a leg part 516. In a case where the “heart” hits the game medium, a determination as to which part is hit is performed, and the reference addition value is adjusted based on the hit part. A method for determining whether or not the part is hit is not particularly limited and can use a known method. Specifically, the method is exemplified by deciding parameters such as the ejection position, ejection direction, and ejection speed of the “heart” based on the operation input of the player and performing a physical calculation based on the decided parameters. The part division is not limited to the above example and can be appropriately set depending on the content of the game and the type of game medium.

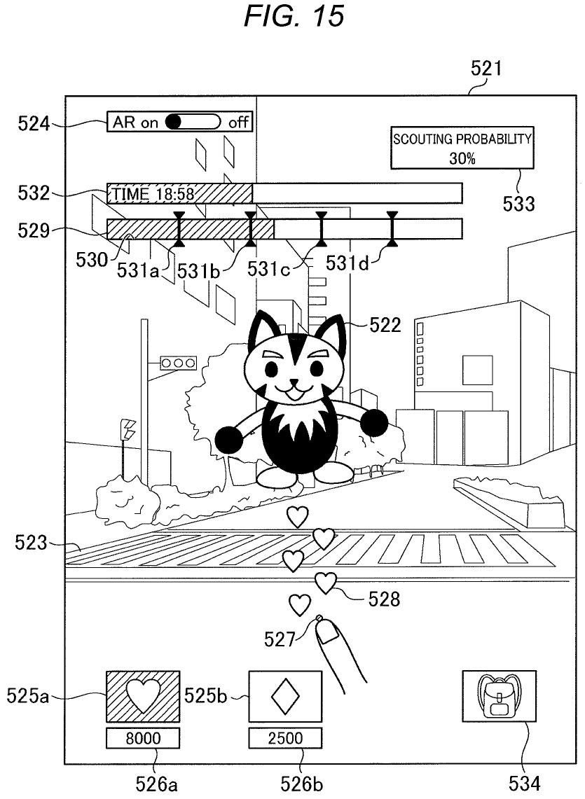

In the case of part division in FIG. 14, the following patterns are exemplified as a specific example of the adjustment pattern 507 in FIG. 15. A “pattern 01” of the adjustment pattern 507 is a pattern in which adjustment is not performed. That is, in a case where one “heart” hits a game medium “101” or “102”, the giving probability is changed by “+0.5%” regardless of the hit part.

A “pattern 41” of the adjustment pattern 507 is a pattern in which the reference addition value is decreased to half until the “heart” hits each of the head part 512, the torso part 513, the waist part 514, the arm part 515, and the leg part 516 of the game medium twice. That is, for a game medium “401”, an addition value of “0.3%×½” is added to the giving probability for every “heart” hitting the game medium “401” until the player hits above each part with the “heart” twice. After the player hits each part above with the “heart” twice, an addition value of “0.3%” is added to the giving probability for every “heart” regardless of the hit part.

A “pattern 51” of the adjustment pattern 507 is a pattern in which the reference addition value is decreased to half until the “diamond” hits each of the head part 512, the torso part 513, the waist part 514, the arm part 515, and the leg part 516 of the game medium three times. That is, for a game medium “501”, an addition value of “0.2%×½” is added to the giving probability for every “heart” hitting the game medium “501” until the player hits above each part with the “diamond” three times. After the player hits each part above with the “diamond” three times, an addition value of “0.2%” is added to the giving probability for every “heart” regardless of the hit part.

A “pattern 52” of the adjustment pattern 507 is a pattern in which the reference addition value is decreased to half at all times in a case where the “heart” hits the part of the game medium other than the head part 512. That is, for a game medium “502”, in a case where the “heart” hits the head part 512, an addition value of “0.2%” is added to the giving probability for every “heart”. In addition, for the game medium “502”, in a case where the “heart” hits the torso part 513, the waist part 514, the arm part 515, or the leg part 516, an addition value of “0.2%×½” is added to the giving probability for every “heart”.

As described above, by setting various adjustment patterns for each game medium, a game element such as finding an appropriate strategy for each game medium is added, and the interest of the game can be improved.

FIG. 15 is one example of the display screen displayed on the player terminal which corresponds to at least one embodiment of the present invention. A game medium 522 as a giving target is displayed on a background image 523 in a display screen 521. The background image 523 is an image based on the image of the surrounding area of the player terminal captured by the camera unit 45. The background image 523 can be switched between the image based on the image of the surrounding area of the player terminal and a predetermined background image stored in the player terminal by an AR switch button 524.

Selection fields 525a and 525b are for selecting an item to hit the game medium. In a case where the player selects the selection field 525a by a tap operation or the like, the “heart” is selected. In a case where the player selects the selection field 525b with a tap operation or the like, the “diamond” is selected. In the example in FIG. 15, the selection field 525a is hatched. The hatching indicates that the “heart” is currently selected. Possession number fields 526a and 526b represent the number of possessions of “hearts” or “diamonds”. In a case where the number of possessions becomes equal to zero, the item cannot be used.

The ejection position 527 is a position set as the ejection position of the “heart” or the like by an instruction provided by a finger or the like of the player. A heart 528 is the “heart” ejected by the player. For example, in a case where the ejection position is set by an instruction provided by a touch operation performed by the player, the ejection of the “heart” or the like from the position continues while the touch operation continues. The ejected “heart” or the like moves along a predetermined trajectory. The predetermined trajectory is not particularly limited and is preferably a trajectory of which a hitting point is easily predicted by the player. Specifically, the predetermined trajectory is exemplified by a trajectory of a parabola that is upward convex with respect to a horizontal plane in a game space.

The game medium 522 is controlled to move in the game space randomly or in accordance with a predetermined rule. The player decides the ejection position to hit the game medium with the “heart” or the like by considering the moving trajectory of the “heart” or the like while changing the position of the player terminal to display the game medium on the display screen 521. The position of the player terminal is detected by the gyrosensor or the like of the player terminal. Such a configuration adds a game quality of hitting the game medium with the “heart” or the like by recognizing the motion of the game medium, and can improve the interest of the game.

In addition, the state of the game medium 522 is controlled to change randomly or in accordance with a predetermined rule. The manner of changing the state is not particularly limited and is exemplified by, for example, a state where the addition value at the time of hitting with the “heart” or the like is decreased, or a state where the addition value at the time of hitting with the “heart” or the like is increased. Such a configuration adds a game quality of hitting the game medium with the “heart” or the like by confirming the change of the state of the game medium, and can improve the interest of the game.

In addition, in a case where a predetermined condition is satisfied, it is preferable to control the game medium 522 to be advantageous to the player in a manner such as stopping the motion of the game medium 522 or setting the game medium 522 to be in slow motion. The predetermined condition is not particularly limited and is exemplified by, for example, ejecting the “heart” or the like continuously for a predetermined time or longer or hitting a part of the game medium 522 set as a weak point with the “heart” or the like. Such a configuration can improve the strategic quality of the game.

In a case where the “heart” or the like hits the game medium 522, the addition value calculated based on the reference addition value and the adjustment pattern is added to the initial giving probability of the game medium 522. The addition value may be configured such that the addition value is internally accumulated, and the accumulated addition value is added to the giving probability when the accumulated addition value exceeds a predetermined threshold.

A bar 530 hatched in a gauge 529 expands rightward depending on the added addition value or the number of “hearts” or the like hitting the game medium. Thresholds 531a, 531b, 531c, and 531d are displayed in the gauge 529. Each time the bar 530 exceeds above each threshold, a display of a giving probability field 533 is updated. Regardless of whether or not the threshold is exceeded, for example, the display of the giving probability field 533 may be updated each time the “heart” or the like hits the game medium 522.

In addition, each time the bar 530 exceeds above each threshold, the game medium 522 is displayed by changing the saturation or the like of the game medium 522 such that the game medium 522 approximates the state of coloring set as the typical image. Such a configuration enables the player to perceive the degree of increase in giving probability without staring at the giving probability field 533 or the bar 530 and focus on the operation of hitting the game medium 522 with the “heart” or the like.

A time limit display field 532 shows a time limit in which the operation of hitting the game medium 522 with the “heart” or the like can be performed. In a case where the player terminal can receive the operation for hitting the game medium 522 with the “heart” or the like, a bar displayed in the time limit display field 532 is displayed as decreasing along with an elapse of time.

In a case where the bar 530 reaches the right end of the gauge 529 before the end of the time limit shown in the time limit display field 532, a determination as to whether or not to give the game medium 522 is performed in the computer apparatus based on the giving probability in that case. In addition, in a case where the bar 530 exceeds the predetermined threshold at the end of the time limit, a determination as to whether or not to give the game medium 522 is performed in the computer apparatus based on the giving probability in that case. In addition, in a case where the bar 530 does not exceed the predetermined threshold at the end of the time limit, the event is finished without performing a determination as to whether or not to give the game medium 522. The predetermined threshold is not particularly limited and, for example, can be appropriately set depending on the content of the game and the type of game medium, such as any of the thresholds 531a to 531d or a value corresponding to a location of half of the gauge 529.

An item field 534 is a field for using the item possessed by the player. For example, in a case where the player selects the item field 534 by a tap operation, a list of items possessed by the player and usable in the event is displayed. By selecting the item to be used from the list of items, a predetermined effect set for the item is exhibited. The predetermined effect is not particularly limited and is exemplified by, for example, increasing the giving probability of the game medium or substantially extending the time limit.

The flowchart in FIG. 12 will be described again. The player terminal determines whether or not the giving probability of the game medium changed in step S49 satisfies the predetermined condition 1 (step S50). For example, the predetermined condition 1 is exemplified by the giving probability of the game medium reaching the upper limit due to the addition value reaching the addition value upper limit set for the game medium. In a case where it is determined that the predetermined condition 1 is satisfied (Yes in step S50), a transition is made to step S52. In a case where it is determined that the predetermined condition 1 is not satisfied (No in step S50), the processes of step S47 to step. S50 are repeated until the time limit is reached.

In a case where the time limit is reached, the player terminal determines whether or not the giving probability of the game medium in the case where the time limit is reached satisfies a predetermined condition 2 (step S51). For example, the predetermined condition 2 is exemplified by the giving probability after change reaching a predetermined threshold (for example, a value obtained by adding 50% of the addition value upper limit to the initial giving probability). In a case where it is determined that the predetermined condition 2 is not satisfied (No in step S51), the process is terminated without giving the game medium. In a case where it is determined that the predetermined condition 2 is satisfied (Yes in step S51), information related to the giving probability of the game medium in that case is transmitted to the computer apparatus from the player terminal (step S52).

Next, the computer apparatus receives the information from the player terminal (step S53). Next, the player terminal determines whether or not to give the game medium to the player based on the received information related to the giving probability of the game medium (step S54). In a case where the computer apparatus determines not to give the game medium to the player (No in step S54), the process is terminated without giving the game medium to the player.

In a case where the computer apparatus determines not to give the game medium to the player (No in step S54), and the predetermined condition 1 is satisfied (Yes in step S50), the processes of step S47 to step S50 may be resumed within the range of the remaining time limit in the case where the predetermined condition 1 is satisfied.

In a case where the computer apparatus determines to give the game medium to the player (Yes in step S54), the computer apparatus performs a process of updating the player information to include the information related to the game medium as the giving target (step S55). Next, the computer apparatus transmits the updated information to the player terminal (step S56). Next, the player terminal receives the information from the computer apparatus (step S57) and terminates the program execution process.

While an example of calculating the change of the giving probability on the player terminal side is described in FIG. 12, the change of the giving probability (final giving probability) may be configured to be calculated on the computer apparatus side. For example, the player terminal may be configured to transmit information related to the number of “hearts” or the like hitting the game medium to the computer apparatus, and the computer apparatus may be configured to calculate the final giving probability based on the information.

As one aspect of the seventh embodiment, by giving the predetermined item to the player based on the moving distance of the player terminal in the real world and setting the game medium to be givable to the player based on the satisfaction of the predetermined condition by the item, the interest of the game can be improved in the game that uses the position of the player terminal.

As one aspect of the seventh embodiment, by giving the game medium on condition that the game medium displayed on the player terminal is brought into contact with the predetermined item, a game quality of bringing the game medium into contact with the predetermined item is added, and the interest of the game can be improved further than that in the case of giving the game medium based on simple drawing or the like.

As one aspect of the seventh embodiment, by setting the game medium to be givable to the player based on the number or amount of the predetermined item satisfying the predetermined condition, a joy of bringing the game medium into contact with a large number or amount of item occurs, and the interest of the game can be improved. In addition, for example, an excitement of bringing the game medium into contact with the predetermined item one after another can be given to the player, and the interest of the game can be improved.

As one aspect of the seventh embodiment, by increasing the probability of the game medium displayed on the player terminal as the number or amount of the predetermined item satisfying the predetermined condition is increased, a strong motivation for an action of bringing the game medium into contact with a large number or amount of item can be made, and the degree of immersion in the game can be increased.

As one aspect of the seventh embodiment, by changing the probability of giving the game medium depending on the rarity set for the game medium, game balance is easily maintained. For example, by setting a low giving probability for the game medium of high rarity and setting a high giving probability for the game medium of low rarity, the game balance is easily maintained. In addition, the exhilaration of the player in a case where the game medium of high rarity is acquired can be further improved.

As one aspect of the seventh embodiment, by changing the probability of giving the game medium depending on the timing at which the predetermined item satisfies the predetermined condition, a game quality of considering the timing of use or the like of the predetermined item is added, and the interest of the game can be improved.

As one aspect of the seventh embodiment, by setting the game medium to be givable to the player based on the giving probability at a time when a predetermined period elapses from the start of the event for giving the game medium, a strategy for increasing the giving probability within the predetermined period is required, and the interest of the game can be improved.

As one aspect of the seventh embodiment, by changing the probability of giving the game medium based on the part of the game medium contacting the predetermined item, a game quality of determining which part is hit by the “heart” or the like is added, and the interest of the game can be improved.

As one aspect of the seventh embodiment, by giving the game medium on condition that the game medium moving on the screen of the player terminal is brought into contact with the predetermined item, a game quality of predicting the motion of the game medium and performing an appropriate operation to hit the game medium with the predetermined item is added, and the interest of the game can be improved.

As one aspect of the seventh embodiment, by displaying the game medium on the image corresponding to the real image captured by the player terminal, the ability of interaction between the game and the real world can be increased, and, for example, the player can be caused to feel that the game medium is present in the real world.

As one aspect of the seventh embodiment, by displaying the game medium by changing the color of at least a part of the game medium depending on the number or amount of the predetermined item satisfying the predetermined condition, the player can perceive the number or amount of the predetermined item satisfying the predetermined condition while staring at the game medium. Consequently, for example, an action of taking eyes off the game medium in order to check the number or amount of the predetermined item satisfying the predetermined condition is not necessary, and the degree of immersion in the game can be maintained at a high level.

In the seventh embodiment, regarding each of the “player terminal”, the “player”, the “computer apparatus”, the “game”, the “moving distance”, the “positional information”, the “position”, the predetermined item”, “giving”, the “game medium”, the “information related to the game medium”, and the “predetermined condition”, the contents disclosed in the first embodiment can be adopted within a necessary range.

In addition, in the seventh embodiment, for example, “hitting” refers to a determination that the predetermined item collides or comes into contact with the game medium in the game. In addition, the “attribute” specifically refers to a common property of the game medium, a classification standard of the game medium, or the like. For example, the common property of the game medium is exemplified by a property deciding superiority or inferiority with respect to the enemy character in the virtual battle. For example, the classification standard of the game medium is exemplified by a rank of the game medium decided based on the magnitude of the parameter used in the game or the magnitude of the effect in the case of using the game medium, or the rarity of the game medium. In addition, the “rarity” refers to an indicator showing the rareness of the game medium. For example, as the rarity of the game medium is increased, the opportunity for the player to obtain the game medium is decreased.

### APPENDIX

The description of the embodiments described above has been described so that those having ordinary knowledge in the field to which the invention belongs can carry out the following invention.

[1] A game program executed in a computer apparatus connectable by communication to a player terminal operated by a player, the program causing the computer apparatus to function as:

an item giver that gives a predetermined item to the player depending on a moving distance of the player terminal in a real world;

a transmitter that transmits information related to a game medium givable to the player to the player terminal; and

a game medium giver that sets the game medium displayed on the player terminal to be givable to the player based on satisfaction of a predetermined condition by the predetermined item.

[2] The game program according to [1],

wherein the predetermined condition is bringing the game medium displayed on the player terminal into contact with the predetermined item by an operation performed on the player terminal.

[3] The game program according to [1] or [2],

wherein the game medium giver sets the game medium displayed on the player terminal to be givable to the player based on the number or amount of the predetermined item satisfying the predetermined condition.

[4] The game program according to any one of [1] to [3],

wherein the game medium giver gives the game medium displayed on the player terminal to the player with a higher probability as the number or amount of the predetermined item satisfying the predetermined condition is increased.

[5] The game program according to [4],

wherein the game medium giver changes the probability of giving the game medium depending on rarity set for the game medium.

[6] The game program according to [4] or [5],

wherein the game medium giver changes the probability of giving the game medium depending on a timing at which the predetermined item satisfies the predetermined condition.

[7] The game program according to any one of [4] to [6],

wherein the game medium giver sets the game medium to be givable to the player based on the giving probability at a time when a predetermined period elapses from the start of an event for giving the game medium in the player terminal.

[8] The game program according to any one of [4] to [7],

wherein the game medium giver changes the probability of giving the game medium based on a part of the game medium contacting the predetermined item.

[9] The game program according to any one of [1] to [8],

wherein the predetermined condition is bringing the game medium moving on a screen of the player terminal into contact with the predetermined item by an operation performed on the player terminal.

[10] The game program according to any one of [1] to [9],

wherein the player terminal displays the game medium on an image corresponding to a real image captured by the player terminal.

[11] The game program according to any one of [1] to [10],

wherein the player terminal displays the game medium by changing a color of at least a part of the game medium depending on the number or amount of the predetermined item satisfying the predetermined condition.

[12] A computer apparatus in which the game program according to any one of [1] to [11] is installed.
[13] A game system implemented by a player terminal operated by a player and a computer apparatus connectable by communication to the player terminal, the system comprising:

an item giver that gives a predetermined item to the player depending on a moving distance of the player terminal in a real world;

a transmitter that transmits information related to a game medium givable to the player to the player terminal;

a receiver that receives the information related to the game medium givable to the player from the computer apparatus;

a display that displays the game medium givable to the player on the player terminal; and

a game medium giver that sets the game medium displayed by the display to be givable to the player based on satisfaction of a predetermined condition by the predetermined item.

[14] The game system according to [13],

wherein the display displays the game medium on an image corresponding to a real image captured by the player terminal.

[15] The game system according to [13] or [14],

wherein the display displays the game medium by changing a color of at least a part of the game medium depending on the number or amount of the predetermined item satisfying the predetermined condition.

[16] A game program executed in a player terminal in a game system implemented by the player terminal operated by a player and a computer apparatus connectable by communication to the player terminal, the game system giving a predetermined item to the player depending on a moving distance of the player terminal in a real world, transmitting information related to a game medium givable to the player to the player terminal, and giving the game medium displayed on the player terminal to the player based on satisfaction of a predetermined condition by the predetermined item, the program causing the player terminal to function as:

a transmitter that transmits positional information related to a position of the player terminal in the real world to the computer apparatus;

a receiver that receives the information related to the game medium givable to the player from the computer apparatus; and

a display that displays the game medium based on the information related to the game medium.

[17] A player terminal in which the game program according to [16] is installed.
[18] A method for controlling a game program executed in a computer apparatus connectable by communication to a player terminal operated by a player, the method comprising:

an item giving step of giving a predetermined item to the player depending on a moving distance of the player terminal in a real world;

a transmission step of transmitting information related to a game medium givable to the player to the player terminal; and

a game medium giving step of setting the game medium displayed on the player terminal to be givable to the player based on satisfaction of a predetermined condition by the predetermined item.

[19] A method for controlling a game executed in a game system including a player terminal operated by a player and a computer apparatus connectable by communication to the player terminal, the method comprising:

an item giving step of giving a predetermined item to the player depending on a moving distance of the player terminal in a real world;

a transmission step of transmitting information related to a game medium givable to the player to the player terminal;

a reception step of receiving the information related to the game medium givable to the player from the computer apparatus;

a display step of displaying the game medium givable to the player on the player terminal; and

a game medium giving step of setting the game medium displayed in the display step to be givable to the player based on satisfaction of a predetermined condition by the predetermined item.

### REFERENCE SIGNS LIST

1 computer apparatus
11 controller
12 RAM
13 storage
14 communication interface
2 game system
3 player terminal
31 controller
32 RAM
33 storage
34 sound processor
35 sound output device
36 sensor unit
37 frame memory
38 graphics processor
39 display unit
40 display screen
41 touch input unit
42 communication interface
43 interface unit
44 input unit
45 camera unit
4 communication network

1. A non-transitory computer-readable recording medium including a game program executed in a computer apparatus connectable by communication to a player terminal operated by a player, the program causing the computer apparatus to function as:
an item giver that gives a predetermined item to the player depending on a moving distance of the player terminal in a real world;
a transmitter that transmits information related to a game medium givable to the player to the player terminal; and
a game medium giver that sets the game medium displayed on the player terminal to be givable to the player based on satisfaction of a predetermined condition by the predetermined item.

2. The non-transitory computer-readable recording medium according to claim 1,
wherein the predetermined condition is bringing the game medium displayed on the player terminal into contact with the predetermined item by an operation performed on the player terminal.

3. The non-transitory computer-readable recording medium according to claim 1,
wherein the game medium giver sets the game medium displayed on the player terminal to be givable to the player based on the number or amount of the predetermined item satisfying the predetermined condition.

4. The non-transitory computer-readable recording medium according to claim 1,
wherein the game medium giver gives the game medium displayed on the player terminal to the player with a higher probability as the number or amount of the predetermined item satisfying the predetermined condition is increased.

5. The non-transitory computer-readable recording medium according to claim 4,
wherein the game medium giver changes the probability of giving the game medium depending on rarity set for the game medium.

6. The non-transitory computer-readable recording medium according to claim 4,
wherein the game medium giver changes the probability of giving the game medium depending on a timing at which the predetermined item satisfies the predetermined condition.

7. The non-transitory computer-readable recording medium according to claim 4,
wherein the game medium giver sets the game medium to be givable to the player based on the giving probability at a time when a predetermined period elapses from the start of an event for giving the game medium in the player terminal.

8. The non-transitory computer-readable recording medium according to claim 4,
wherein the game medium giver changes the probability of giving the game medium based on a part of the game medium contacting the predetermined item.

9. The non-transitory computer-readable recording medium according to claim 1,
wherein the predetermined condition is bringing the game medium moving on a screen of the player terminal into contact with the predetermined item by an operation performed on the player terminal.

10. The non-transitory computer-readable recording medium according to claim 1,
wherein the player terminal displays the game medium on an image corresponding to a real image captured by the player terminal.

11. The non-transitory computer-readable recording medium according to claim 1,
wherein the player terminal displays the game medium by changing a color of at least a part of the game medium depending on the number or amount of the predetermined item satisfying the predetermined condition.

12. (canceled)

13. A game system implemented by a player terminal operated by a player and a computer apparatus connectable by communication to the player terminal, the system comprising:
an item giver that gives a predetermined item to the player depending on a moving distance of the player terminal in a real world;
a transmitter that transmits information related to a game medium givable to the player to the player terminal;
a receiver that receives the information related to the game medium givable to the player from the computer apparatus;
a display that displays the game medium givable to the player on the player terminal; and
a game medium giver that sets the game medium displayed by the display to be givable to the player based on satisfaction of a predetermined condition by the predetermined item.

14. The game system according to claim 13,
wherein the display displays the game medium on an image corresponding to a real image captured by the player terminal.

15. The game system according to claim 13,
wherein the display displays the game medium by changing a color of at least a part of the game medium depending on the number or amount of the predetermined item satisfying the predetermined condition.

16. A non-transitory computer-readable recording medium including a game program executed in a player terminal in a game system implemented by the player terminal operated by a player and a computer apparatus connectable by communication to the player terminal, the game system giving a predetermined item to the player depending on a moving distance of the player terminal in a real world, transmitting information related to a game medium givable to the player to the player terminal, and giving the game medium displayed on the player terminal to the player based on satisfaction of a predetermined condition by the predetermined item, the program causing the player terminal to function as:
a transmitter that transmits positional information related to a position of the player terminal in the real world to the computer apparatus;
a receiver that receives the information related to the game medium givable to the player from the computer apparatus; and
a display that displays the game medium based on the information related to the game medium.
